(19) United States
(12) Patent Application Publication
(10) Pub. No.: US 2026/0325919 A1
(43) Pub. Date: Oct. 22, 2026

(54) TORSO ORIENTATION AND FORWARD MOTION ESTIMATION FOR RUNNING

(71) Applicant: Garmin International, Inc., Olathe, KS (US)

(72) Inventors: Yuqi Li, Cochrane (CA); Christopher J. Kulach, Cochrane (CA)

(21) Appl. No.: 19/650,991

(22) Filed: Apr. 17, 2026

Related U.S. Application Data
(60) Provisional application No. 63/790,118, filed on Apr. 17, 2025.

(51) Int. Cl. A63B 24/00; G01P 15/18

(52) U.S. Cl. CPC A63B 24/0062; G01P 15/18; A63B 2220/44; A63B 2220/836; A63B 2230/62

(57) ABSTRACT

An electronic device comprises a processor or processing unit configured to receive acceleration data from an accelerometer measuring an acceleration of a user engaged in a stride based activity; receive angular velocity data from a gyroscope measuring an angular velocity of the user; perform a first data rotation on the acceleration data to a non rotating frame over one stride of the user using the angular velocity data; average the rotated acceleration data over one stride of the user; update a torso orientation of the user using the averaged, rotated acceleration data; correct yaw data of the updated torso orientation resulting from errors due to bias and drift; perform a second data rotation on the acceleration data from a sensor frame to a direction of motion frame; and output estimates of a forward velocity of the user resulting from performing the second data rotation.

### RELATED APPLICATIONS

The current patent application is a non-provisional utility patent application which claims priority benefit, with regard to all common subject matter, under 35 U.S.C. § 119(e) of earlier-filed U.S. Provisional Application Ser. No. 63/790,118; entitled “TORSO ORIENTATION AND FORWARD MOTION ESTIMATION FOR RUNNING”; and filed Apr. 17, 2025. The Provisional Application is hereby incorporated by reference, in its entirety, into the current patent application.

### BACKGROUND

Motion sensors are often included in wearable electronic devices in order to measure motion of the human body. The sensor measurements may be taken during activities such as walking, hiking, swimming, bicycling, golfing, tennis playing, and the like, with certain measurements being particularly relevant to jogging and running. As an example, a motion sensor device embedded in a wearable chest strap may capture a range of Running Dynamics (RD) metrics, including cadence, vertical oscillation (VO), ground contact time, stance time, ground contact balance, vertical ratio, and step length. A drawback of current RD metrics is that the metrics do not capture motion 216 in the forward direction of a runner. Accurately measuring forward motion of the runner would provide additional analysis of running biomechanics, which would enable advanced evaluation of movement patterns—such as gait analysis—and improve the understanding of running performance and economy. A key technical requirement for measuring forward motion velocity is the accurate estimation of the runner's orientation. However, this remains a challenge due to the complex dynamics involved during running.

### SUMMARY

Embodiments of the present technology provide an electronic device that can be worn by a user while running. The electronic device receives data from an accelerometer and a gyroscope. The electronic device performs a three-dimensional data rotation on the data from the accelerometer using the data from the gyroscope in order to determine more accurate estimates of a forward velocity of the user. Exemplary embodiments of the electronic device broadly comprise a processor or processing unit configured to receive acceleration data from a three-axis accelerometer measuring an acceleration of a user engaged in a stride-based activity; receive angular velocity data from a three-axis gyroscope measuring an angular velocity of the user; perform a first three-dimensional data rotation on the acceleration data to a non-rotating frame over one stride of the user using the angular velocity data; average the rotated acceleration data over one stride of the user; update a torso orientation of the user using the averaged, rotated acceleration data; correct a yaw data portion of the updated torso orientation resulting from errors due to bias and drift; perform a second three-dimensional data rotation on the acceleration data from a sensor frame to a direction-of-motion frame; and output estimates of a forward velocity of the user resulting from performing the second three-dimensional data rotation.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF DRAWINGS

Embodiments of the present technology are described in detail below with reference to the attached drawing figures, wherein:

FIG. 1 is a perspective view of a first electronic device constructed in accordance with various embodiments of the present technology;

FIG. 2 is a perspective view of a second electronic device constructed in accordance with additional embodiments of the present technology;

FIG. 3 is a bottom view of the first electronic device;

FIG. 4 is a schematic block diagram of various electronic components of the first electronic device and the second electronic device;

FIG. 5 is an environmental view of a user wearing the first electronic device and the second electronic device while running; and

FIG. 6 is a schematic block diagram of a sensor data processing unit configured to output more accurate estimates of the user's forward velocity.

The drawing figures do not limit the present technology to the specific embodiments disclosed and described herein. The drawings are not necessarily to scale, emphasis instead being placed upon clearly illustrating the principles of the technology.

### DETAILED DESCRIPTION OF THE TECHNOLOGY

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

Relational and/or directional terms, such as “above”, “below”, “up”, “upper”, “upward”, “down”, “lower”, “downward”, “top”, “bottom”, “outer”, “inner”, “left”, “right”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. However, embodiments of the technology in practice may be positioned and oriented in other ways or move in other directions. Therefore, the terms do not limit the scope of the present technology.

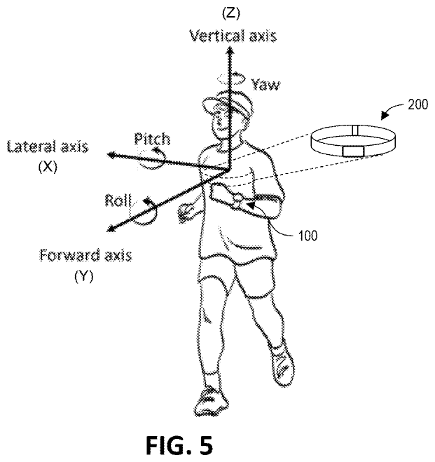

The present technology broadly comprises a first electronic device and a second electronic device. The technology integrates an inertia sensor, which includes a triaxial accelerometer and a triaxial gyroscope (or angular velocity sensor) to measure dynamic and orientation-related characteristics of the user's movement during an activity such as running, which is depicted in FIG. 5. These inertial measurement components enable the system to capture linear accelerations and angular velocities of the torso, allowing for accurate estimation of the system's orientation relative to the direction-of-motion frame. Specifically, orientation is characterized in terms of pitch, roll, and yaw, and is computed based on data obtained from the inertia sensor. To enhance orientation estimation, particularly during dynamic activities such as running, the technology utilizes the cyclical nature of repetitive motion. Gravitational acceleration is estimated over each motion cycle by stabilizing accelerometer data in a non-rotating frame derived from gyroscope integration. Furthermore, yaw accuracy is improved by identifying and removing constant bias components over each cycle, thereby mitigating drift due to gyroscopic errors. The inertia sensor is designed to be affixed to the upper body—such as integrated into a chest-mounted heart rate monitor—allowing it to effectively capture the kinematic behavior of the torso during locomotion.

The technology may be used to rotate accelerometer data from the sensor frame into the direction-of-motion frame. This transformation enables a more accurate analysis of motion characteristics that are aligned with the subject's actual travel direction, improving the estimation of forward velocity and related biomechanical metrics. By working in the direction-of-motion frame, parameters can be interpreted with respect to the physical path of motion rather than the orientation of the sensor alone.

The technology may be used during various forms of repetitive or cyclical motion. In some examples, the motion may be a striding motion, such as walking or running, in which case the motion cycle may be defined as a stride or a step. In other embodiments, the motion may involve cycling, where the motion cycle may correspond to a full rotation of the bike pedals. The technology may also be applied to horseback riding, which introduces a different motion profile but similarly exhibits cyclical dynamics that can be analyzed over each motion cycle.

The inertia sensor may be attached to a variety of subjects and locations depending on the application. In some cases, the sensor may be attached to a runner, and more specifically, to the runner's torso, such as via a chest-mounted heart rate monitor. In other use cases, the sensor may be affixed to an animal, including but not limited to a horse, enabling motion analysis for veterinary diagnostics, sports performance, or biomechanical research in equestrian disciplines.

Using the orientation-corrected data, the technology may be configured to compute a variety of biomechanical parameters. These may include step speed loss, which reflects inefficiencies in forward propulsion; vertical oscillation, capturing the upward motion of the torso; lateral displacement, representing side-to-side motion; and angular oscillation, which quantifies rotational variations of the torso or frame during movement. These metrics, when computed in the direction-of-motion frame, provide enhanced insight into movement dynamics and performance.

The technology can calculate an improved estimation of torso orientation during running by leveraging inertial data collected from the 6-axis inertia sensor comprising a 3-axis accelerometer and a 3-axis gyroscope. Orientation estimation—including pitch, roll, and yaw—is refined by exploiting the cyclical nature of human gait. Specifically, the technology may define each stride as a motion cycle, during which the gyroscope is used to compute rotational changes, resetting integration at each initial ground contact to avoid long-term drift. Accelerometer data is rotated into a non-rotating frame aligned with the torso's orientation at the start of the stride. Since the linear acceleration of the torso averages to zero over a stride, the mean of the stabilized accelerometer data yields a robust estimate of gravitational acceleration, which can be used to update the orientation filter. Additionally, yaw estimates can be corrected by modeling their cyclical behavior over strides, fitting a linear trend to identify and compensate for both yaw drift and constant bias due to lack of heading reference.

With accurate torso orientation established, the technology can estimate the runner's forward speed by rotating raw accelerometer data from the sensor frame to the direction-of-motion frame. This transformation allows the technology to isolate acceleration in the forward axis while minimizing contamination from vertical and lateral movements. By integrating forward-directed acceleration over time—while applying corrections to suppress drift and remove bias—the system can track changes in forward velocity throughout each stride. These forward speed profiles can be synchronized with stride events such as initial ground contact and toe-off, providing a detailed picture of how speed fluctuates during the stance and flight phases of each step.

Using the forward speed profile, the technology can define and compute a biomechanical performance metric known as step speed loss. This metric may be calculated as the difference between the forward speed at the start of ground contact and the minimum forward speed observed during the stance phase of the step. A higher step speed loss indicates a greater deceleration during foot contact, which may reflect inefficiencies in propulsion or shock absorption. By analyzing this metric across strides, the technology can offer insight into running economy and performance, as well as identify asymmetries or irregularities that may indicate fatigue or injury risk.

Building on the step speed loss metric, the technology may derive an estimate of running economy, which serves as an indicator of how efficiently a runner converts metabolic energy into forward motion. Step speed loss reflects the energy cost of overcoming deceleration during ground contact, and when aggregated over multiple strides, it can serve as a proxy for mechanical efficiency. By combining this information with additional running dynamics—such as cadence, ground contact time, vertical oscillation, and forward speed—the technology can compute a summary-level running economy score for each run. This value may be reported directly on the wrist-worn electronic device as part of post-activity analysis, providing runners with actionable insight into how efficiently they ran, and helping to identify areas for performance optimization.

To support long-term progress tracking, running economy may also be computed at a user-level by averaging running economy values across multiple workouts, analogous to the current VO₂ max tracking methodology. This historical averaging enables athletes to monitor improvements over training cycles or assess the impact of fatigue, training load, or form changes.

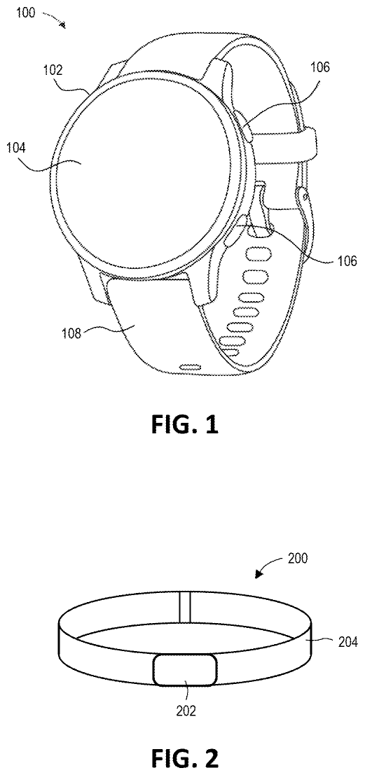

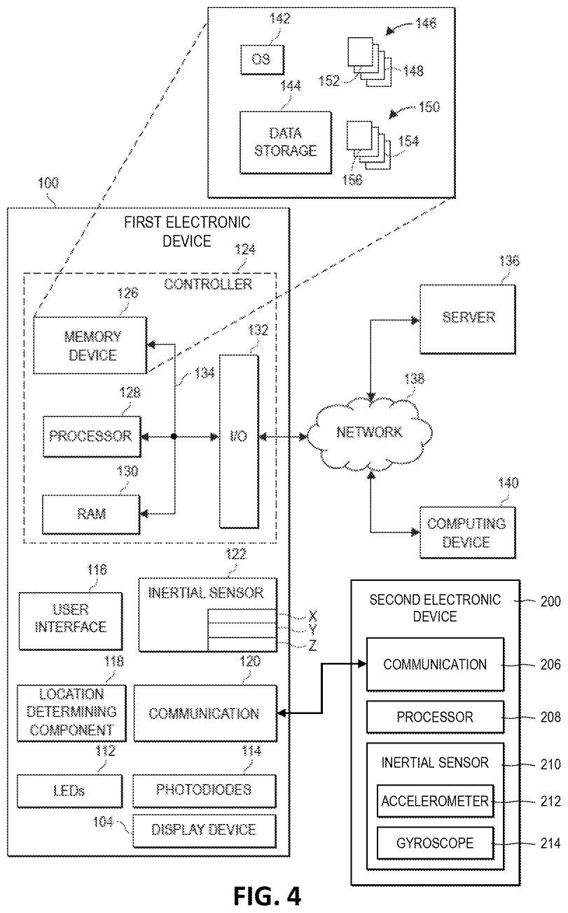

Embodiments of the technology will now be described in more detail with reference to the drawing figures. Referring initially to FIGS. 1, 3, and 4, a first electronic device 100 is illustrated. The electronic device 100 may be worn on a user's wrist, among other locations on the user's body. Referring to FIGS. 2 and 4, a second electronic device 200 is illustrated. The electronic device 200 may be worn on the user's torso, e.g., the user's chest. In various embodiments, the electronic device 200 may also be known as a heart rate monitor (HRM). The electronic device 200 may make sensor measurements of the user's motion and communicate sensor-related data to the electronic device 100.

The electronic device 100 broadly comprises a housing 102, a display device 104, one or more control buttons 106, a strap 108, a housing bottom wall 110, a plurality of light-emitting diodes (LEDs) 112, a plurality of photodiodes 114, a user interface 116, a location determining component 118 (e.g., a global positioning system (GPS) receiver, assisted-GPS, etc.), a communication module 120, an inertial sensor 122 (e.g., accelerometer, gyroscope, etc.), and a controller 124. The electronic device 200 broadly comprises a housing 202, a strap 204, a communication module 206, a processor 208, and an inertial sensor 210.

The housing 102 is configured to substantially enclose various components of the device 100. The housing 102 may be formed from a lightweight and impact-resistant material such as plastic, nylon, or combinations thereof, for example. The housing 102 may be formed from a conductive material, a non-conductive material, and combinations thereof. The housing 102 may include one or more gaskets, e.g., a seal, to make it substantially waterproof and/or water resistant. The housing 102 may include a location for a battery and/or another power source for powering one or more components of the device 100. The housing 102 may be a singular piece or may include multiple sections. The housing 102 may include one or more side walls coupled to the bottom wall 110 which is configured to contact the skin on the user's wrist. In addition, the one or more side walls and the bottom wall 110 may include one or more through-hole openings in which other components are accessible.

The display device 104 may include a liquid crystal display (LCD), a thin film transistor (TFT), a light-emitting diode (LED), a light-emitting polymer (LEP), and/or a polymer light-emitting diode (PLED). The display device 104 may be capable of presenting text, graphical, and/or pictorial information. The display device 104 may be backlit such that it may be viewed in the dark or other low-light environments. One example embodiment of the display device 104 is a 100-pixel by 64-pixel film compensated super-twisted nematic display (FSTN) including a bright white light-emitting diode (LED) backlight. The display device 104 may include a transparent lens that covers and/or protects components of the device 100. The display device 104 may be provided with a touch screen to receive input (e.g., data, commands, etc.) from a user. For example, a user may operate the device 100 by touching the touch screen and/or by performing gestures on the screen. In some embodiments, the touch screen may be a capacitive touch screen, a resistive touch screen, an infrared touch screen, combinations thereof, and the like. The device 100 may further include one or more input/output (I/O) devices (e.g., a keypad, buttons, a wireless input device, a thumbwheel input device, etc.). The I/O devices may include one or more audio I/O devices, such as a microphone, speakers, and the like. Additionally, user input may be provided from movement of the housing 102, for example, an inertial sensor(s), e.g., accelerometer, may be used to identify vertical, horizontal, angular movement and/or tapping of the housing 102 or the lens.

The control buttons 106 may be part of the user interface 116 and may include four control buttons 106 associated with, or coupled to, the housing 102, as shown in FIG. 1. While FIG. 1 illustrates four control buttons 106 associated with the housing 102, it is understood that the device 100 may include a greater or lesser number of control buttons 106. In one embodiment, each control button 106 is configured to generally control a function of the device 100. Functions of the device 100 may be associated with a location determining component and/or a performance monitoring component. Functions of the device 100 may include, but are not limited to, displaying a current geographic location of the device 100, mapping a location on the display 104, locating a desired location and displaying the desired location on the display 104, and presenting information based on a physiological characteristic (e.g., heart-rate (HR), heart-rate variability, blood pressure, or SpO2 percentage, for example) or a physiological response (e.g., stress level, body energy level, etc.) of the individual.

The strap 108 enables the device 100 to be worn by a user. In particular, when the device is worn by the user, one or more LEDs and one or more photodiodes may be securely placed against the skin of a user. The strap 108 is coupled to and/or integrated with the housing 102 and may be removably secured to the housing 102 via attachment of securing elements to corresponding connecting elements. Some examples of securing elements and/or connecting elements include, but are not limited to, hooks, latches, clamps, snaps, and the like. The strap 108 may be made of a lightweight and resilient thermoplastic elastomer and/or a fabric, for example, such that the strap 108 may encircle a portion of a user without discomfort while securing the device 100 to the user. The strap 108 may be configured to attach to various portions of the user, such as the user's leg, waist, wrist, forearm, upper arm, and/or torso.

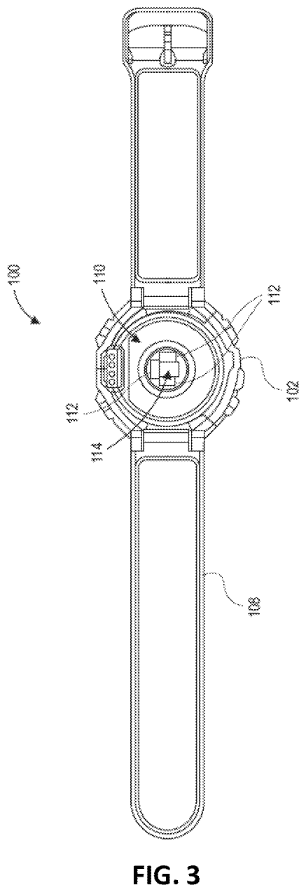

Referring to FIG. 3, a bottom view of the device 100 configured for determining and providing cardiac information, such as heart rate (HR) and pulse oximetry information is depicted. The device 100 includes an optical signal assembly including one or more light sources, such as LEDs 112. The optical signal assembly also includes one or more light detectors such as photodiodes 114. In some embodiments, the LEDs 112 output visible and/or non-visible light and the one or more photodiodes 114 receive transmissions or reflections of the visible and/or non-visible light and convert the received light into electrical current, which, in some embodiments, is converted into a digital value by an analog to digital converter. Each LED 112 generates light based on an intensity determined by the processor. For example, LEDs 112 may include any combination of green light-emitting diodes (LEDs), red LEDs, and/or infrared or near-infrared LEDs that may be configured by the processor to emit light into the user's skin. In some embodiments, the red LEDs operate at a wavelength between approximately 610 and 700 nm. In some embodiments, a first LED produces light at approximately 630 nm, a second LED operates at approximately 940 nm, and a third LED operates at approximately 660 nm.

The photodiodes 114 are capable of receiving transmissions or reflections of visible-light and/or infrared (IR) light output by the LEDs 112 into the user's skin and generating a SpO2 signal based on the intensity of the reflected light received by each photodiode 114. The light intensity signals generated by the one or more photodiodes 114 may be communicated to the processor. In embodiments, the controller 124 includes an integrated photometric front end for signal processing and digitization. In other embodiments, the controller 124 is coupled with a photometric front end. The photometric front end may include filters for the light intensity signals and analog-to-digital converters to digitize the light intensity signals into SpO2 signals including a cardiac signal component associated with the user's heartbeat.

Typically, when the device 100 is worn against the user's body (e.g., wrist, fingertip, ear, etc.), the one or more LEDs 112 are positioned against the user's skin to emit light into the user's skin and the one or more photodiodes 114 are positioned near the LEDs 112 to receive light emitted by the one or more emitters after transmission through or reflection from the user's skin. The controller 124 may receive a SpO2 signal based on a light intensity signal output by one or more photodiodes 114 based on an intensity of light after transmission of the light through or reflection from the user's skin that has been received by the photodiodes 114. In both the transmitted and reflected uses, the intensity of measured light may be modulated by the cardiac cycle due to variation in tissue blood perfusion during the cardiac cycle. In activity environments, the intensity of measured light may also be strongly influenced by many other factors, including, but not limited to, static and/or variable ambient light intensity, body motion at measurement location, static and/or variable sensor pressure on the skin, motion of the sensor relative to the body at the measurement location, breathing, and/or light barriers (e.g., hair, opaque skin layers, sweat, etc.). Relative to these sources, the cardiac cycle component of the SpO2 signal can be very weak, for example, by one or more orders of magnitude.

The user interface 116 of the device 100 may include a “soft” keyboard that is presented on the display device 104 of the device 100, an external hardware keyboard communicating via a wired or a wireless connection (e.g., a Bluetooth keyboard), and/or an external mouse, or any other suitable user-input device or component. As described earlier, the user interface 116 may also include or communicate with a microphone capable of receiving voice input from a vehicle operator as well as a display device 104 having a touch input.

The location determining component 118 generally determines a current geolocation of the device 100 and may process a first electronic signal, such as radio frequency (RF) electronic signals, from a global navigation satellite system (GNSS) such as the global positioning system (GPS) primarily used in the United States, the GLONASS system primarily used in the Soviet Union, or the Galileo system primarily used in Europe. The location determining component 118 may include satellite navigation receivers, processors, controllers, other computing devices, or combinations thereof, and memory. The location determining component 118 may be in electronic communication with an antenna (not shown) that may wirelessly receive an electronic signal from one or more of the previously-mentioned satellite systems and provide the first electronic signal to location determining component 118. The location determining component 118 may process the electronic signal, which includes data and information, from which geographic information such as the current geolocation is determined. The current geolocation may include geographic coordinates, such as the latitude and longitude, of the current geographic location of the device 100. The location determining component 118 may communicate the current geolocation to the processor 128. Generally, the location determining component 118 is capable of determining continuous position, velocity, time, and direction (heading) information.

The communication module 120 may enable the device 100 to communicate with a computing device 140 and/or a server 136 via any suitable wired or wireless communication protocol independently or using I/O circuitry 132. The wired or wireless network 138 may include a wireless telephony network (e.g., GSM, CDMA, LTE, etc.), one or more standard of the Institute of Electrical and Electronics Engineers (IEEE), such as 802.11 or 802.16 (Wi-Max) standards, Wi-Fi standards promulgated by the Wi-Fi Alliance, Bluetooth standards promulgated by the Bluetooth Special Interest Group, a near field communication standard (e.g., ISO/IEC 18092, standards provided by the NFC Forum, etc.), and so on. Wired communications are also contemplated such as through universal serial bus (USB), Ethernet, serial connections, and so forth.

The device 100 may be configured to communicate via one or more networks 138 with a cellular provider and an Internet provider to receive mobile phone service and various content, respectively. Content may represent a variety of different content, examples of which include, but are not limited to: map data, which may include route information; web pages; services; music; photographs; video; email service; instant messaging; device drivers; real-time and/or historical weather data; instruction updates; and so forth.

The controller 124 may include a memory device 126, a microprocessor (MP) 128, a random-access memory (RAM) 130, and an input/output (I/O) circuitry 132, all of which may be communicatively interconnected via an address/data bus 134. Although the I/O circuitry 132 is depicted in FIG. 4 as a single block, the I/O circuitry 132 may include a number of different types of I/O circuits. The memory device 126 may include an operating system 142, a data storage device 144, a plurality of software applications 146, and/or a plurality of software routines 150. The operating system 142 of memory device 126 may include any of a plurality of mobile platforms, such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage device 144 of memory device 126 may include application data for the plurality of applications 146, routine data for the plurality of routines 150, and other data necessary to interact with the server 136 through the network 138. In particular, the data storage device 144 may include cardiac component data associated with one or more individuals. The cardiac component data may include one or more compilations of recorded physiological characteristics of the user, including, but not limited to, a hemoglobin saturation values, a heart rate (HR), a heart-rate variability (HRV), a blood pressure, motion data, a determined distance traveled, a speed of movement, calculated calories burned, body temperature, and the like. In some embodiments, the controller 124 may also include or otherwise be operatively coupled for communication with other data storage mechanisms (e.g., one or more hard disk drives, optical storage drives, solid state storage devices, etc.) that may reside within the device 100 and/or operatively coupled to the network 138 and/or server device 136.

The memory device 126 and the RAM 130 each may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, optical disks, flash memory, thumb drives, universal serial bus (USB) drives, solid state memory, solid state drives (SSDs), or the like, or combinations thereof. In some embodiments, the memory device 126 and the RAM 130 each may be embedded in, or integrated in the same package as, the processor 128. The memory device 126 and the RAM 130 each may include, constitute, or embody, a non-transitory “computer-readable medium”. The memory device 126 and the RAM 130 each may store the instructions, code, code statements, code segments, software, firmware, programs, applications, apps, services, daemons, or the like that are executed by the processor 128. The memory device 126 and the RAM 130 each is in electronic communication with the processor 128 and may also store data that is received by the processor 128 or the device in which the processor 128 is implemented. The processor 128 may further store data or intermediate results generated during processing, calculations, and/or computations as well as data or final results after processing, calculations, and/or computations. In addition, the memory device 126 and the RAM 130 each may store settings, lookup tables, text data, documents from word processing software, spreadsheet software and other software applications, databases, and the like.

The processor 128 may comprise one or more processors that include electronic hardware components such as microprocessors (single-core or multi-core), microcontrollers, digital signal processors (DSPs), field-programmable gate arrays (FPGAs), analog and/or digital application-specific integrated circuits (ASICs), artificial intelligence circuitry, graphics processing units (GPUs), neural processing units (NPUs), artificial intelligence (AI) accelerators, tensor processing units (TPUs), or the like, or combinations thereof. The processor 128 may further include system on a chip (SoC) architectures. The processor 128 may generally execute, process, or run algorithms, instructions, code, code segments, code statements, software, firmware, programs, applications, apps, processes, services, daemons, or the like. The processor 128 may also include hardware components such as registers, finite-state machines, sequential and combinational logic, configurable logic blocks, and other electronic circuits that can perform the functions necessary for the operation of the current invention. In certain embodiments, the processor 128 may include multiple computational components and functional blocks that are packaged separately but function as a single unit. In some embodiments, the processor 128 may further include multiprocessor architectures, parallel processor architectures, processor clusters, and the like, which provide high performance computing. The processor 128 may be in electronic communication with the other electronic components of the electronic device 100 through serial or parallel links that include universal busses, address busses, data busses, control lines, and the like. In addition, the processor 128 may include analog to digital converters (ADCs) to convert analog electronic signals to digital data values in binary form (such as by sampling), or streams of digital data values, and/or digital to analog converters (DACs) to convert digital data values, or streams of digital data values, to analog electronic signals. The processor 128 is operable, configured, programmed, and/or trained to perform the following functions, operations, processes, methods, and/or algorithms of the electronic device 100 by utilizing hardware, software, firmware, or combinations thereof. Other components, such as the communication module 120 and the memory device 126 and the RAM 130 may be utilized as well.

With reference to the controller 124, it should be understood that controller 124 may include multiple microprocessors 128, multiple RAMs 130 and multiple memory devices 126. The controller 124 may implement the RAM 130 and the memory devices 126 as semiconductor memories, magnetically readable memories, and/or optically readable memories, for example. The one or more processors 128 may be adapted and configured to execute any of the plurality of software applications 146 and/or any of the plurality of software routines 150 residing in the memory device 126, in addition to other software applications. One of the plurality of applications 146 may be a client application 152 that may be implemented as a series of machine-readable instructions for performing the various functions associated with implementing the performance monitoring system as well as receiving information at, displaying information on, and transmitting information from the device 100. The client application 152 may function to implement a system wherein the front-end components communicate and cooperate with back-end components as described above. The client application 152 may include machine-readable instructions for implementing the user interface 116 to allow a user to input commands to, and receive information from, the device 100. One of the plurality of applications 146 may be a native web browser 148, such as Apple's Safari®, Google Android™ mobile web browser, Microsoft Internet Explorer® for Mobile, Opera Mobile™, that may be implemented as a series of machine-readable instructions for receiving, interpreting, and displaying web page information from the server device 136 or other back-end components while also receiving inputs from the device 100. Another application of the plurality of applications 146 may include an embedded web browser 148 that may be implemented as a series of machine-readable instructions for receiving, interpreting, and displaying web page information from the server device 136 or other back-end components within the client application 152.

The client applications 146 or routines 150 may include an accelerometer routine 154 that determines the acceleration and direction of movements of the device 100, which correlate to the acceleration, direction, and movement of the user. The accelerometer routine 154 may receive and process data from the inertial sensor 122 to determine one or more vectors describing the motion of the user for use with the client application 152. In some embodiments where the inertial sensor 122 includes an accelerometer having X-axis, Y-axis, and Z-axis accelerometers, the accelerometer routine 154 may combine the data from each accelerometer to establish the vectors describing the motion of the user through three-dimensional space. In some embodiments, the accelerometer routine 154 may use data pertaining to less than three axes.

The client applications 146 or routines 150 may further include a velocity routine 156 that coordinates with the location determining component 118 to determine or obtain velocity and direction information for use with one or more of the plurality of applications, such as the client application 152, or for use with other routines.

The user may also launch or initiate any other suitable user interface application (e.g., the native web browser 148, or any other one of the plurality of software applications 146) to access the server device 136 to implement the monitoring process. Additionally, the user may launch the client application 152 from the device 100 to access the server device 136 to implement the monitoring process.

With reference to the electronic device 200, the housing 202 is configured to substantially enclose various components of the device 200. The housing 202 may be formed from a lightweight and impact-resistant material such as plastic, nylon, or combinations thereof, for example. The housing 202 may be formed from a conductive material, a non-conductive material, and combinations thereof. The housing 202 may include one or more gaskets, e.g., a seal, to make it substantially waterproof and/or water resistant. The housing 202 may include a location for a battery and/or another power source for powering one or more components of the device 200. The housing 202 may be a singular piece or may include multiple sections.

The strap 204 is coupled to and/or integrated with the housing 202 and may be removably secured to the housing 202 via attachment of securing elements to corresponding connecting elements. Some examples of securing elements and/or connecting elements include, but are not limited to, hooks, latches, clamps, snaps, and the like. The strap 204 may be made of a lightweight and resilient thermoplastic elastomer and/or a fabric, for example, such that the strap 204 may encircle a portion of the user, or attach to clothing items of the user, without discomfort while securing the device 200 to the user.

The communication module 206 may include the same or similar components as the communication module 120 and may function and operate in the same or similar manner. The communication module 206 may facilitate communication of data and the like between the electronic device 200 and the electronic device 100.

The processor 208 includes the same or similar components as the processor 128 and may function and operate in the same or similar manner.

The electronic device 100 and the electronic device 200 are typically utilized during various forms of repetitive or cyclical motion. In some examples, the motion may involve cycling, where the motion cycle may correspond to a full rotation of the bike pedals. In other examples, the motion may include horseback riding, which introduces a different motion profile but similarly exhibits cyclical dynamics that can be analyzed over each motion cycle. In still other examples, the motion may include the cyclical motion of swimming or rowing. In an example shown in FIG. 5, the motion may be a striding motion, such as walking or running, in which case the motion cycle may be defined as a stride or a step. The remaining components along with the function and operation of the electronic device 100 and the electronic device 200 are discussed below with reference to FIG. 5 in which the user is wearing the electronic device 100 and the electronic device 200 while running.

The inertial sensor 122 and the inertial sensor 210 may each include the following components and may each function and operate as follows. The inertial sensor 122 and the inertial sensor 210 may each include an accelerometer 212 and a gyroscope 214. The accelerometer 212 includes an electromechanical sensor that measures acceleration—the rate of change of an object's velocity—along the X, Y, and Z axes. The accelerometer 212 functions by detecting the deflection of a tiny internal mass suspended by springs (often using microelectromechanical systems (MEMS) capacitive, piezoelectric, or piezoresistive technologies). The accelerometer 212 captures both the linear acceleration caused by user torso movement, and the gravitational acceleration within the sensor frame. The gyroscope 214 may utilize MEMS devices integrated with silicon chips to measure angular velocity (rate of rotation) around the X, Y, and Z axes. In various embodiments, the gyroscope 214 measures the angular velocity of the user's torso.

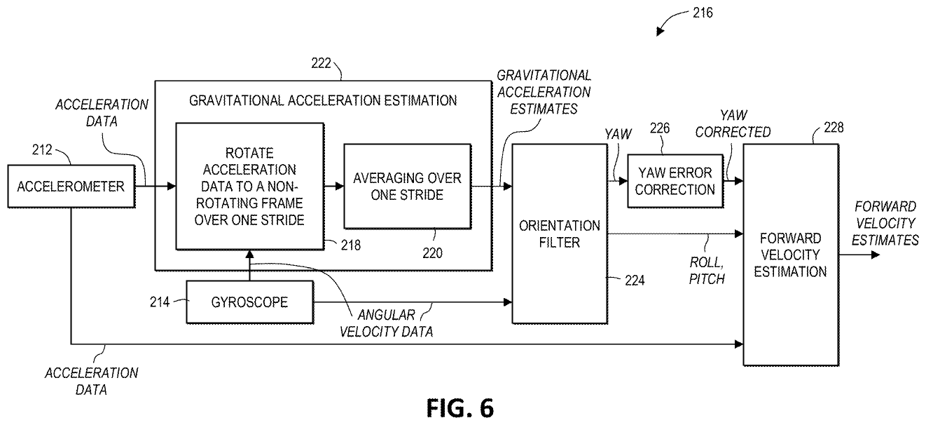

The accelerometer 212 may measure, or sample, the user's acceleration at a regular time period interval such that a measurement is made, or data is sampled, for example, multiple times per second. The acceleration data may include a first acceleration value for the X axis, a second acceleration value for the Y axis, and a third acceleration value for the Z axis for each measurement or sample. Likewise, the gyroscope 214 may measure, or sample, the user's angular velocity at a regular time period interval such that a measurement is made, or data is sampled, for example, multiple times per second. The angular velocity data may include any data representative of angular velocity, angular acceleration, and/or other angular metrics. In some examples, the angular velocity data includes a stream of samples representing angular velocity along three axes, such as an X axis, a Y axis, and a Z axis. In other examples, angular velocity data may include a pitch angular velocity value, a roll angular velocity value, and a yaw angular velocity value. Typically, the accelerometer 212 and the gyroscope 214 measure or sample data at the same rate. The measurements, or sensor data, are utilized with, or input to, a sensor data processing unit 216, shown in FIG. 6, which outputs forward velocity estimate data. The sensor data processing unit 216 includes the following modules: a first module 218, a second module 220, a gravitational acceleration estimation module 222, an orientation filter module 224, a yaw error correction module 226, and a forward velocity estimation module 228. The modules of the sensor data processing unit 216 may be implemented as hardware, such as electronic circuitry in at least one of the electronic device 100 and the electronic device 200, or as software, such as applications and/or algorithms. In various embodiments, the functions and operations of the sensor data processing unit 216 may be performed by the processor 128, the processor 208, or both. In some embodiments, the sensor data from the accelerometer 212 and the gyroscope 214 may be communicated from the electronic device 200 to the electronic device 100 to be processed by the sensor data processing unit 216 on the electronic device 100. In other embodiments, the forward velocity estimate data output by the sensor data processing unit 216 may be communicated from the electronic device 200 to the electronic device 100.

The first module 218 receives (a stream of) acceleration data from the accelerometer 212 and (a stream of) angular velocity data from the gyroscope 214 and is configured to rotate acceleration data, such as a three-dimensional data rotation, from the accelerometer 212 to a non-rotating frame over one stride of the user using angular velocity data. The second module 220 receives data from the first module 218 and is configured to average, i.e., determine the mean value, of the rotated acceleration data over one stride of the user. The gravitational acceleration estimation module 222 comprises the first module 218 and the second module 220 and is configured to output estimates of the acceleration due to gravity on the user including the averages of the rotated acceleration data. The orientation filter module 224 receives data from the gravitational acceleration estimation module 222 and the gyroscope 214. The orientation filter module 224 is configured to determine and output data describing, or related to, the yaw, the roll, and the pitch of the user which has been updated using the estimates of the acceleration due to gravity from the gravitational acceleration estimation module 222. In some examples, the orientation filter module 224 updates a torso orientation of the user using averaged, rotated acceleration data. The torso orientation may include data reflecting pitch, roll, and yaw of the torso. The yaw error correction module 226 receives the yaw data from the orientation filter module 224 and is configured to correct errors in the yaw data corresponding to the torso orientation resulting from bias and drift that are inherent in the yaw data and output corrected yaw data. The forward velocity estimation module 228 receives the acceleration data from the accelerometer 212, the corrected yaw data from the yaw error correction module 226, and the roll data and the pitch data from the orientation filter module 224. The forward velocity estimation module 228 rotates the acceleration data, such as a three-dimensional data rotation, from the accelerometer 212 using the updated pitch and roll data from the orientation filter module 224 and the corrected yaw data from the yaw error correction module 226 and outputs corrected and more accurate estimates of the forward velocity of the user while the user is moving, such as while running. In some examples, the updated pitch and roll data portions comprise parts of the updated torso orientation data. The forward velocity data may be utilized in determining other metrics which can help improve the user's active performance.

In various embodiments, the orientation filter module 224 may determine updated pitch, roll, and yaw data using the angular velocity data from the gyroscope 214 and the gravitational acceleration estimates from the gravitational acceleration estimation module 222. The yaw error correction module 226 may determine and apply yaw bias and drift corrections based on yaw data over a plurality of strides, such as over a fixed or sliding window of strides.

In various embodiments, the forward velocity estimation module 228 may determine forward velocity by rotating the acceleration data from the sensor frame to the direction-of-motion frame and processing the forward-axis acceleration data over time, including applying one or more bias, drift, or smoothing corrections. In some embodiments, the processor 208 of the electronic device 200 may perform some or all of the functions of the sensor data processing unit 216. In other embodiments, some or all of such functions may be performed by the processor 128 of the electronic device 100, or cooperatively by the electronic device 100 and the electronic device 200.

Each module of the sensor data processing unit 216 may output a respective one of a stream of values at a regular time period interval such as the measurement or sample rate of the accelerometer 212 and the gyroscope 214. Accordingly, the sensor data processing unit 216 may output a respective one of a stream of forward velocity estimate values at the regular time period interval.

The function and operation of the sensor data processing unit 216 is described in more detail as follows. Since velocity measurements are cyclical over a stride, the linear acceleration of the torso, expressed in a non-rotating frame, has a zero mean over a stride cycle. It is trivial to note that the gravitational acceleration in this non-rotating frame remains constant. Given these principles, the data from the gyroscope 214 may be utilized to rotate the data from the accelerometer 212 to a non-rotating frame of reference throughout the stride cycle of the user.

In various embodiments, the technology may identify a stride and detect an initial ground contact event based on one or more features derived from the acceleration data, the angular velocity data, or both. For example, the sensor data processing unit 216 may monitor one or more periodic characteristics of the user's motion, such as peaks, troughs, threshold crossings, zero crossings, slope changes, extrema, or other repeating signal features in one or more axes of the accelerometer 212 and/or the gyroscope 214, to segment the motion into successive stride intervals. An initial ground contact event for a given stride may be identified as a selected one of these detected features, and the corresponding time may be used as the stride start time t_0 for that stride. In some embodiments, the detected event may be validated using timing, amplitude, periodicity, or cross-sensor consistency criteria to reduce false detections. Upon detection of the initial ground contact event, the gyroscope integration may be reset or reinitialized for the new stride so that the orientation change for that stride is computed relative to the sensor frame at the beginning of the stride.

Consider a stride that begins with initial ground contact at time t₀ and has a duration of T. The change in orientation during the stride, starting from initial ground contact, can be computed using gyroscope measurements, as expressed in Equation (1) and Equation (2):

$${q}_{{s}_{0}}^{s} ( t ) = {\int }_{{t}_{0}}^{t} \frac{1}{2} {q}_{{s}_{0}}^{s} ( t ) ⊗ {ω}^{s} ( t ) , {t}_{0} \leq t \leq {t}_{0} + T \qquad ( 1 )$$

$${q}_{{s}_{0}}^{s} ( {t}_{0} ) = [ 1000 ] \qquad ( 2 )$$

where ω^{s}(t) is constructed from gyroscope measurements.

$${q}_{{s}_{0}}^{s} ( t )$$

represents the quaternion describing the orientation change of the sensor-frame since initial ground contact, where s denotes the rotating sensor-frame due to torso motion and s₀ is the sensor-frame at the moment of initial ground contact. Equation (2) indicates that the gyroscope integrator is reset at the initial ground contact of each stride. The data from the accelerometer 212 can be expressed as shown in Equation (3):

z^{s}(t)=g^{s}(t)+a^{s}(t) (3)
where g^{s}(t) and a^{s}(t) represent the gravitational acceleration and linear acceleration, respectively, both measured in sensor-frame s. The data from the accelerometer 212 can be “stabilized” in the s₀ frame using the functions of Equation (4):

$${q}_{{s}_{0}}^{s} ( t ) ⊗ {z}^{s} ⊗ {q}_{{s}_{0}}^{{s}^{*}} ( t ) = {z}^{{s}_{0}} ( t ) = {g}^{{s}_{0}} + {a}^{{s}_{0}} ( t ) \qquad ( 4 )$$

Note that g^{s}^{₀} is a constant representing the gravitational acceleration measured at the non-rotating frame s₀ over the stride. The mean of the “stabilized” data from the accelerometer 212 over the stride can then be expressed as shown in Equation (5):

$$\frac{{\int }_{{t}_{0}}^{{t}_{0} + T} {z}^{{s}_{0}} ( t ) dt}{T} = {g}^{{s}_{0}} + \frac{{\int }_{{t}_{0}}^{{t}_{0} + T} {a}^{{s}_{0}} ( t ) dt}{T} = {g}^{{s}_{0}} \qquad ( 5 )$$

which provides an accurate estimate of the gravitational acceleration in the s₀ frame, as the linear acceleration is removed over the stride cycle. The gravitational acceleration estimates are output by the gravitational acceleration estimation module 222 and received by the orientation filter module 224.

In various embodiments, the technology may determine the direction-of-motion frame based on the estimated orientation of the user and the corrected yaw data produced by the sensor data processing unit 216. For example, the orientation filter module 224 and the yaw error correction module 226 may together provide pitch, roll, and corrected yaw information that define the angular relationship between the sensor frame and the direction-of-motion frame for a given time or sample. Using these orientation values, the forward velocity estimation module 228 may compute a rotation, such as a three-dimensional rotation matrix, quaternion-based transformation, or other coordinate transformation, that maps acceleration data from the sensor frame into the direction-of-motion frame. In some embodiments, the forward axis of the direction-of-motion frame may be aligned with an estimated instantaneous travel direction of the user, while the remaining axes may be defined relative to gravity and the user's orientation.

With the cyclical property of the motion of the user, the yaw angle in the direction-of-motion frame should exhibit a zero-mean value over each stride. In practice, yaw estimates are affected by bias—due to the absence of a heading reference—and by drift arising from a bias of the gyroscope 214. To address this, a method is proposed that computes the yaw angle mean value for each stride and fits a linear curve to these means over several strides. The slope of the fitted line represents yaw drift, while the intercept reflects yaw bias. Consider the n^{th} stride, its yaw stride mean value can be modeled as shown in Equation (6):

ψₙ=dtₙ+b (6)
where tₙ denotes the initial ground contact time. Parameters d and b represent the yaw drift and bias, respectively. These parameters are to be estimated and can be organized into a vector x=[d, b]^{T}. Yaw mean values from N strides are used in the curve fitting, which can be written as shown in Equation (7):

z=[ψ₀ψ₁ . . . ψ_{N-1}]^{T} (7)

The measurement model can then be written as shown in Equation (8):

z=Hx (8)
where

$$H = [ \begin{matrix}{t}_{0} & 1 \\ ⋮ & ⋮ \\ {t}_{n} & 1 \\ ⋮ & ⋮ \\ {t}_{N - 1} & 1\end{matrix} ]$$

A least square solution to estimate x is shown in Equation (9):

\hat{x}=(H^{T}H)⁻¹H^{T}z (9)

These estimated parameters are then used to correct the yaw estimates which are output by the yaw error correction module 226, thereby improving overall yaw accuracy.

The improved orientation estimate, including the corrected yaw estimate, is then applied to rotate data from the accelerometer 212 from the sensor frame (of reference) to the direction-of-motion frame (of reference), enabling accurate estimation of the runner's 3D velocity in the direction-of-motion frame. The forward speed estimates (of the user's torso) output by the sensor data processing unit 216 provide a within-step speed profile, which supports deeper analysis of running biomechanics. For instance, the degree of deceleration during each step helps identify the speed loss in the braking phase of the stance. This reflects the amount of propulsive force required during the subsequent acceleration phase to regain speed and maintain a target running velocity. Therefore, step speed loss can be used to enhance running power estimation, quantify the energy needed to sustain running, and correlate with various performance and running economy metrics. These insights can potentially help runners identify inefficiencies in their stride, allowing them to adjust their running style to improve performance, and minimize injury risk.

Thus, in various examples, the electronic device 200 may be attached to the user's upper body, such as the torso or chest, and may include an inertial sensor 210 configured as a motion parameter sensor having a 3-axis accelerometer 212 and a 3-axis gyroscope 214. The inertial sensor 210 may provide acceleration data and angular velocity data to the sensor data processing unit 216, which may determine an orientation of the user relative to a direction-of-motion frame, the orientation including pitch, roll, and yaw. Over each motion cycle, such as a stride, the sensor data processing unit 216 may estimate gravitational acceleration by rotating the acceleration data to a non-rotating frame and averaging the rotated acceleration data over the motion cycle, and may further correct the yaw by removing a constant component, such as a stride-wise mean yaw component, so as to reduce bias and improve the accuracy of the determined orientation and forward velocity estimates. Further, by determining the user's torso orientation relative to the direction-of-motion frame, including pitch, roll, and yaw based on data from the inertial sensor 210, the sensor data processing unit 216 may provide improved motion metrics for the user. For example, the torso orientation data may be used together with the forward velocity estimate data to generate more accurate and more informative performance-related metrics, including metrics that reflect within-stride motion, running biomechanics, motion efficiency, and other characteristics of the user's movement.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either present technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. An electronic device comprising:
a processor or processing unit configured to:
receive acceleration data from a three-axis accelerometer measuring an acceleration of a user engaged in a stride-based activity;
receive angular velocity data from a three-axis gyroscope measuring an angular velocity of the user;
perform a first three-dimensional data rotation on the acceleration data to a non-rotating frame over one stride of the user using the angular velocity data;
average the rotated acceleration data over one stride of the user;
update a torso orientation of the user using the averaged, rotated acceleration data;
correct a yaw data portion of the updated torso orientation resulting from errors due to bias and drift;
perform a second three-dimensional data rotation on the acceleration data from a sensor frame to a direction-of-motion frame; and
output estimates of a forward velocity of the user resulting from performing the second three-dimensional data rotation.

2. The electronic device of claim 1, wherein performing the second three-dimensional data rotation includes using a pitch data portion and a roll data portion of the updated torso orientation and the corrected yaw data portion.

3. The electronic device of claim 1, wherein the acceleration data includes a stream of samples, each sample including a first acceleration value for the X axis, a second acceleration value for the Y axis, and a third acceleration value for the Z axis.

4. The electronic device of claim 1, wherein the angular velocity data includes a stream of samples representing angular velocity along a plurality of axes.

5. The electronic device of claim 1, wherein the electronic device is worn on the user's wrist.

6. The electronic device of claim 1, wherein the electronic device is worn on the user's torso.

7. An electronic device comprising:
a three-axis accelerometer configured to measure an acceleration of a user engaged in a stride-based activity and output measured acceleration data;
a three-axis gyroscope configured to measure an angular velocity of the user and output measured angular velocity data; and
a processor or processing unit configured to:
receive the acceleration data,
receive the angular velocity data,
perform a first three-dimensional data rotation on the acceleration data to a non-rotating frame over one stride of the user using the angular velocity data,
average the rotated acceleration data over one stride of the user,
update a torso orientation of the user using the averaged, rotated acceleration data,
correct a yaw data portion of the updated torso orientation resulting from errors due to bias and drift,
perform a second three-dimensional data rotation on the acceleration data from a sensor frame to a direction-of-motion frame, and
output estimates of a forward velocity of the user resulting from performing the second three-dimensional data rotation.

8. The electronic device of claim 7, wherein performing the second three-dimensional data rotation includes using a pitch data portion and a roll data portion of the updated torso orientation data and the corrected yaw data portion.

9. The electronic device of claim 7, wherein the acceleration data includes a stream of samples, each sample including a first acceleration value for the X axis, a second acceleration value for the Y axis, and a third acceleration value for the Z axis.

10. The electronic device of claim 7, wherein the angular velocity data includes a stream of samples representing angular velocity along a plurality of axes.

11. The electronic device of claim 7, wherein the electronic device is worn on the user's wrist.

12. The electronic device of claim 7, wherein the electronic device is worn on the user's torso.
